(19) United States
(12) Patent Application Publication
(10) Pub. No.: US 2025/0002361 A1
(43) Pub. Date: Jan. 2, 2025

(54) PROCESS FOR PRODUCING SODIUM BROMIDE

(71) Applicant: OBSHCHESTVO S OGRANICHENNOI OTVETSTVENNOSTIU "IRKUTSKAIA NEFTIANAIA KOMPANIA", Irkutsk (RU)

(72) Inventors: Viktor Aleksandrovich BEZBORODOV, Irkutsk (RU); Aleksei Olegovich PIVOVARCHUK, Irkutsk (RU); Evgenii Olegovich CHERTOVSKIKH, Irkutskaya oblast', selo Nepa (RU)

(21) Appl. No.: 18/577,442

(22) PCT Filed: Aug. 26, 2021
(86) PCT No.: PCT/RU2021/000367

§ 371 Date: Apr. 24, 2024

(30) Foreign Application Priority Data
Jul. 6, 2021 (RU) 2021119670

(51) Int. Cl. C01D 3/10; C01D 3/16

(52) U.S. Cl. CPC C01D 3/10; C01D 3/16; C01P 2006/80

(57) ABSTRACT

The invention relates to chemical technology pertaining to mineral salts and can be used in the chemical industry. A process for producing sodium bromide from a bromide-containing polycomponent hydromineral feedstock includes: two-stage oxidation of bromide ions using gaseous chlorine during acidification of a brine: air desorption of elementary bromide: absorption of same using a cooled solution of sodium bromide: and reduction using ammonia in the presence of sodium hydroxide. The resulting concentrate of sodium bromide is evaporated until crystals are formed. The sodium bromide crystals are dried and a mother liquor is used to produce a solution of sodium bromide as a commercial product.

### FIELD OF THE INVENTION

The invention relates to technology for producing inorganic compounds, namely, to the process of producing sodium bromide, which is in the chemical synthesis of organobromine compounds, as well as in the oil and gas industry as a component of heavy process fluids during well drilling, killing, and servicing. The invention relates to chemical technology pertaining to mineral salts and can be used in the chemical industry.

### BACKGROUND OF THE INVENTION

There is a known method for producing metal bromides [1] by reacting oxides, hydroxides, and carbonates of the respective metals with bromine in the presence of reducing agents and water, in which substances that produce only water, or gases, or water and gases together upon oxidation are used as reducing agents, for example, ammonia, urea, cyanamide, ammonium salts, ammonium carbonate, ammonium halides, formaldehyde, hydrazine, formic acid, formamide, oxalic acid, hydroxylamine, and mixtures thereof. According to this method, bromine and a solution of metal hydroxide or carbonate are dosed into an aqueous solution of a reducing agent. Reagents are dosed simultaneously, in portions, or one at a time. The resulting concentrated solution of bromide salt is filtered and evaporated; the finished product is isolated in a known manner. This method [1] is low-productive and energy-intensive and does not provide a high-quality finished product.

There is a method for air desorption of bromine [2]. This method can be used to extract bromine from brines with low bromine content (up to 1 g/dm³).

The process includes the following stages: (1) acidification of the brine; (2) oxidation of bromide ions with chlorine to elementary bromine; (3) distillation of bromine with air; (3) purification of the bromine-air mixture from chlorine; (4) capture of bromine from the bromine-air mixture with chemical absorbers; (5) processing of the resulting intermediates into commercial products; and (6) neutralization of the brine spent.

There is a method for producing bromides of alkali metals, calcium, and ammonium [3] by countercurrent extraction of bromide from a solution of iron (III) bromide with solutions of amine salts in an organic solvent, and re-extraction is performed with solutions of the respective metals in a countercurrent mode. In this case, along with bromides, a solution of iron (III) chloride is obtained.

The document [4] describes a method for producing bromine and its salts, which relates to the technique of absorbing halogens from gas mixtures with liquid absorbers. This invention aims to lower the losses of the reducing agent and alkaline agent, but there is no description of the process for obtaining the bromine-air mixture and the feedstock used.

The patent [5] describes technology for purifying liquid bromine, which includes the absorption of bromine by a 30% sodium bromide solution with the further addition of an alkaline agent to obtain a mixture of sodium bromide as a product.

The closest is the method for producing bromide salts [6], in which bromine is absorbed with an excess amount of urea in an alkaline solution in an amount of 101%-101.5% of the theoretical, followed by heating the solution to 60-65° C. with a calculated amount of bromine water. This method [6] is energy-intensive and does not allow obtaining a high-quality finished product due to the formation of carbonates during the reduction of bromine.

### SUMMARY OF THE INVENTION

The essence of the invention is to obtain high-quality crystalline sodium bromide and its aqueous solution, eliminating the stage of purifying the bromine-air mixture from chlorine and maintaining high purity of the final products and a high degree of bromine extraction.

The technical result is achieved through a two-stage process of oxidation of bromide ions to elementary bromine with gaseous chlorine, which allows minimizing the content of chlorine impurities in the bromine-air mixture without its additional purification.

In the process of absorbing bromine from the bromine-air mixture, a cooled, highly concentrated solution of sodium bromide is used, which increases the degree of bromine absorption to 99%. The use of relatively cheap ammonia or ammonia water as a bromine reducer provides high economic performance in industrial production.

### DETAILED DESCRIPTION OF THE INVENTION

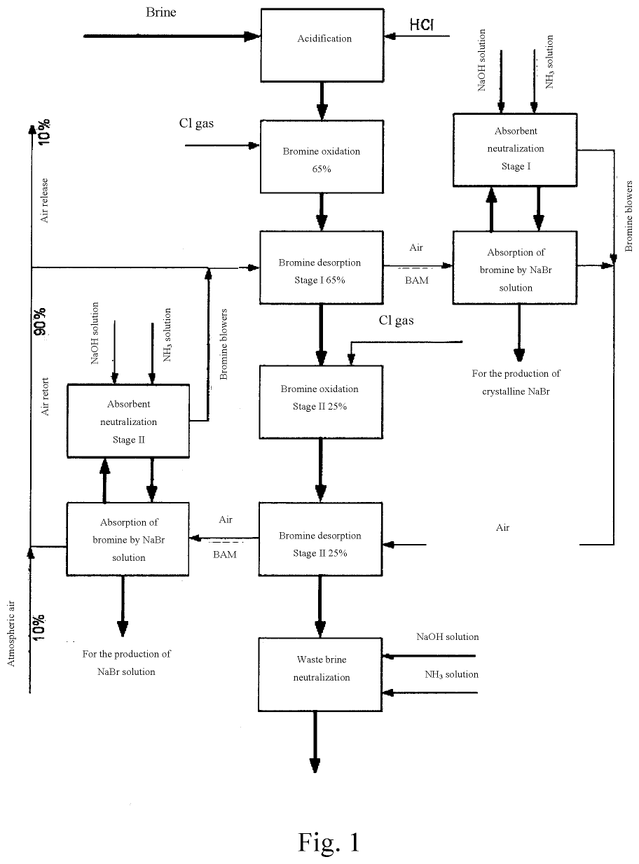

FIG. 1 schematically shows the sequence of actions of the method for producing sodium bromide from a bromide-containing polycomponent hydromineral feedstock. The method includes acidification of the initial brine with mineral acids to prevent hydrolysis of free bromine, then the acidified brine enters Stage I of oxidation with gaseous chlorine to 65% of bromide ions from their initial content to elementary bromine, then the oxidized water enters Stage I of desorption of elementary bromine with atmospheric air that circulates in the system. The bromine-air mixture (BAM) is sent for the absorption of bromine by a solution of sodium bromide (absorbent). The absorbent saturated with bromine is periodically pumped into a collection tank, where the process of reducing bromine to sodium bromide (Stage I) occurs by dosing solutions of sodium hydroxide and ammonia water. The resulting solution of sodium bromide is used to produce crystalline sodium bromide. The air after bromine extraction, which contains some residual bromine, is used for desorption in Stage II. Waste water from Stage I of desorption enters Stage II of oxidation with chlorine gas, at which another 25% of bromide ions are oxidized from their initial content to elementary bromine. Next, water from Stage II of oxidation enters Stage II of air desorption of elementary bromine. Similar to Stage I, the bromine-air mixture is supplied for absorption by the same absorbent (solution of sodium bromide). The absorbent saturated with bromine is periodically pumped into a collection tank, where the process of reducing bromine to sodium bromide (Stage II) occurs by dosing solutions of sodium hydroxide and ammonia water. The resulting solution of sodium bromide is used to produce the commercial form of sodium bromide solution. Waste water is sent for neutralization to prepare it for further disposal.

### EXAMPLES

Example 1. 10.65 m³ of brine with a density of 1,154 kg/m³, with a hydrogen index of 5.84 of the following composition: Σ(Ca2+, Mg2+, Sr2+)=36.51 kg/m³; Feₜₒₜₐₗ=0.0002 kg/m³; Σ(K+, Na+, Li+)=25.40 kg/m³; Cl−=142.92 kg/m³; HCO3−=0.076 kg/m³; SO42−=0.46 kg/m³; Br−=2.94 kg/m³ was acidified with 30% hydrochloric acid to pH=2.5 and subjected to one stage of oxidation with gaseous (anodic) chlorine to a residual content of Br−=1.05 kg/m³, which corresponds to the degree of oxidation=64.3%; elementary bromine was desorbed by atmospheric air and absorbed by a solution of sodium bromide with a concentration of 57.3 kg/m³ on a packed column; the absorbent saturated with elementary bromine was reduced with ammonia water in the presence of sodium hydroxide; the resulting concentrate of sodium bromide (density=1,373 kg/m³, bromide concentration=508 kg/m³) was evaporated on a gas burner until sodium bromide crystals precipitated; the resulting crystals were dried in a drying cabinet; the mother liquor was used to obtain sodium bromide solution as a product. As a result, 20.5 kg of crystalline sodium bromide with a content of the main substance in the dry product of 99.28% was obtained. After Stage I of oxidation and bromine extraction (Br−=1.05 kg/m³), brine in a volume of 10.65 m³ entered Stage II of oxidation with gaseous (anodic) chlorine to a residual content of Br−=0.30 kg/m³, which corresponds to the degree of oxidation for this stage=71.2%. The absorption of sodium bromide solution and the reduction of elementary bromine with ammonia water was performed similarly to Stage I. The resulting concentrate was mixed with the mother liquor after precipitation of sodium bromide crystals from Stage I and evaporated on a gas burner to the required density, and this solution was used as a product. The resulting liquid product was 15.3 dm³ with a density of 1,495 kg/m³ and sodium bromide content of 44.4%. The overall degree of bromine recovery from the brine was 89%.

Example 2. The composition of the initial brine differs from Example 1: 1,152 kg/m³, with a hydrogen index of 5.8 of the following composition: Σ(Ca2+, Mg2+, Sr2+)=41.17 kg/m³; Feₜₒₜₐₗ=0.0002 kg/m³; Σ(K+, Na+, Li+)=31.92 kg/m³; Cl−=151.12 kg/m³; HCO3−=0.03 kg/m³; SO42−=0.52 kg/m³; Br−=2.32 kg/m³. The volume of brine was 10.5 m³. The degree of oxidation of bromine in Stage I was 75%, which corresponds to the residual concentration Br−=0.58 kg/m³ in Stage II, the degree of oxidation was 74.1%, which corresponds to Br=0.15 kg/m³. The following was obtained: 19.2 kg of crystalline sodium bromide with main substance content of 98.51%; 16.6 dm³ of liquid product with a density of 1,470 kg/m³ and sodium bromide content of 44.1%. The overall degree of bromine recovery from the brine was 93.5%.

### REFERENCES

1. USSR Patent No. 8215, Class 12/J. H. Van der Meulen. 1929.
2. Pozin M. E. Technology Pertaining to Mineral Salts. 4^{th} ed. Leningrad, “Khimiya” Publisher, 1974. Part 1.
3. Patent RU2135406C 1. Method for Producing Bromides of Alkali Metals, Calcium, and Ammonium/V. I. Kuzmin, V. N. Kuzmina; Institute of Chemistry and Chemical-Metallurgical Processes of the Siberian Branch of the Russian Academy of Sciences. No. 97108733/25; stated on 28 May 1997; published on 27 Aug. 1999.
4. USSR Inventor's Certificate No. 783229 Class 03 at 3/10/O. V. Lebedev Yu. F. Artamonov, 1980.
5. U.S. Pat. No. 3,145,084. 1964.
6. USSR Inventor's Certificate No. 138232 Class 01 at 9/04/V. I. Ksinzenko, E. A. Dianov, 1960.

1. Method for producing sodium bromide from a bromide-containing polycomponent hydromineral feedstock of field brines of the chloride calcium-magnesium type of oil and gas producing enterprises, which consists of the following: the stream of field brine, purified from dissolved iron, petroleum products, and mechanical impurities, is subjected to preheating to 30-35° C., neutralization of alkalinity, and acidification to pH values in interval 2.5-3.5 using mineral acids to prevent hydrolysis of free bromine, then the oxidation of bromide ions with gaseous chlorine to elementary bromine is performed in two stages: in Stage I, the oxidation of bromide ions to elementary bromine is performed at 65%-70% of its initial content; wherein the air desorption of elementary bromine is performed in a countercurrent mode, and the absorption of elementary bromine from the bromine-air mixture is performed in a column-type mass transfer apparatus with a multidirectional screw nozzle operating in a countercurrent mode, then the absorption of elementary bromine is reduced in the form of complex bromide (Na[Br2]Br) to bromide ions in a circulation tank with ammonia, in the presence of a sodium hydroxide solution, then the resulting sodium bromide solution is purified from bromine and alkali impurities using formic acid, then the purified sodium bromide solution is evaporated in two stages: in Stage I, evaporation is performed to a concentration of sodium bromide of 50% in vacuum evaporators with water vapor recompression; in Stage II, evaporation is performed in evaporators equipped with steam jackets and anchor-type mixers, and evaporation is performed until a pulp containing sodium bromide crystals is obtained, with a ratio of sodium bromide to water of 3:1, the resulting pulp is cooled to 60-62° C. and subjected to centrifugation to separate crystalline sodium bromide from the mother liquor, then the separated crystals are dried in a screw dryer, and after Stage I of desorption, a bromide-containing polycomponent hydromineral feedstock is supplied for the oxidation of bromide ions to elementary bromine with chlorine gas up to 95% of its residual content in order to extract the residual amount of bromine.

2. Method according to claim 1, characterized in that the subsequent operations of air desorption of bromine, absorption of bromine-air mixture, recovery of absorbed elementary bromine, and purification of the resulting sodium bromide solution are similar to Stage I of oxidation.

3. Method according to claim 1, characterized in that the purified sodium bromide solution mixed with the mother liquor from the stage of obtaining crystalline sodium bromide is evaporated to the required density to produce the sodium bromide solution as a commercial product.
